(19) United States
(12) Patent Application Publication
(10) Pub. No.: US 2006/0059984 A1
(43) Pub. Date: Mar. 23, 2006

(54) Coupled spring system for measuring molecular forces

(76) Inventors: Mitchel J. Doktycz, Knoxville, TN (US); David P. Allison, Lenoir City, TN (US)

Correspondence Address: UT-Battelle, LLC;Office of Intellectual Property, One Bethal Valley Road, 4500N, MS-6258, Oak Ridge, TN, 37831, US

(21) Appl. No.: 10/947,799

(22) Filed: Sep. 23, 2004

(51) Int. Cl. G01L 1/04

(52) U.S. Cl. 73/161

(57) ABSTRACT

A coupled spring system is applied to dynamic force spectroscopy measurements. A microcantilever-mounted probe acts as a first spring, and a supported micromachined membrane acts as a second spring. The coupled spring system provides a system spring constant that is lower than either spring individually. By probing different regions of the membrane, the spring constant of the system can be varied.

### STATEMENT REGARDING FEDERALLY SPONSORED RESEARCH OR DEVELOPMENT

The United States Government has rights in this invention pursuant to Contract No. DE-AC05-00OR22725 between the United States Department of Energy and UT-Battelle, LLC.

### BACKGROUND OF THE INVENTION

1. Field of the Invention

The invention relates to force measurement systems, and more particularly to a coupled spring system comprising a microcantilever and a flexible thin film membrane. The combination enables a very soft and variable system spring constant for molecular force measurements.

2. Description of Prior Art

One valuable attribute of the scanning probe microscope is its ability to assess and/or measure forces. These forces can be between the scanning probe and a surface, or between molecules that are specifically tethered or otherwise disposed on these surfaces. The force sensitivity is due to the weak spring of the microcantilever arm upon which the probe is mounted. It is also due to the ability to sensitively measure sub-Angstrom deflections of the spring. The combination can quantify molecular scale forces such as those involved in chemical recognition. Measurements of the energetics between ligands and receptors, the energetics of intramolecular folds in a single protein molecule, and the structural changes within a single enzyme molecule during catalysis have all been demonstrated (Willemsen 2000)¹. The technique is often referred to as dynamic force spectroscopy (DFS) and is proving invaluable for characterizing interactions between molecules and/or surfaces.

Typically, a force-distance curve is collected under a range of force loading rates (Willemsen 2000)¹. FIG. 1 shows a typical force-distance curve, collected in our laboratory, where biotin is tethered to the probe and avidin is bound to the surface. The dashed line is the approach curve. The horizontal portion of the approach curve occurs before the probe makes contact with the surface. Upon contact, the microcantilever arm deflects, and the slope of the force-distance curve in this region depends on the microcantilever spring constant. Upon retraction (solid line), the probe may show adhesion at the point of lift-off. The point of lift-off depends on interaction forces between the probe and the surface. With a suitable length tether or linker molecule, the specific interaction occurring between the tethered biotin and surface bound avidin can be separated from the probe adhesion and observed as a deflection in the horizontal region of the withdrawal curve. The microcantilever spring constant can be measured by a variety of techniques including those of Hutter (1993)2, Cleveland (1993)³, and D'Costa (1995)⁴. Knowledge of the microcantilever spring constant and the deflection measurement can be used to estimate the binding force.

Typically, hundreds to thousands of force-distance curves are collected under various loading rates for an evaluation of binding energetics. Varying the retraction speed, combined with different microcantilever spring constants (i.e., different microcantilevers), results in different loading rates. The need to collect a large number of curves per loading rate is a result of the stochastic or random binding event. The fraction of curves showing a binding event is dependent on numerous factors, including interaction strength and molecular orientation. Examination of various loading rates allows for effective interpretation of the interaction energy. In general, slow loading rates result in lower force measurements than higher loading rates. This is due to thermal energy that can lead to bond disruption. Evans (1997)⁵, based on a model by Bell (1978)⁶, has provided a theoretical interpretation of force measurements by dynamic force spectroscopy and related techniques. Further, these measurements can be related to reaction energies and kinetics carried out in bulk.

Several obstacles stand in the way of maturing dynamic force spectroscopy into a robust technique for routine measurement of molecular interactions. A key obstacle is the coupling chemistry (Willemsen 2000)¹. The orientation of the molecules and the degrees of freedom available are extremely important for producing a binding event. Chemical coupling to the probe must be sufficiently robust to withstand repeated unbinding events. The tether must be stronger than the forces being evaluated. Further, the tether must be sufficiently flexible to provide sampling of a sufficient number of molecular orientations and sufficiently long to separate probe adhesion forces from specific molecular events. A second obstacle is rapidly performing force measurements under a variety of loading rates. Extending the dynamic range of these measurements is critical for identifying weak interactions and for characterizing the activation energy barriers. Our invention directly addresses this shortcoming.

### REFERENCES

1. Willemsen, O. H., Snel, M. M. E., Cambi, A., Greve, J., De Grooth, B. G., and Figdor, C. G., “Biomolecular Interactions Measured by Atomic Force Microscopy”, Biophysical Journal 79, 3267 (2000).
2. Hutter, J. L. and Bechhoefer, J., “Calibration of Atomic-Force Microscope Tips”, Rev. Sci. Instrum. 64, 1868 (1993).
3. Cleveland, J. P., Manne, S., Bocek, D., Hansma, P. K., “A Nondestructive Method for Determining the Spring Constant of Cantilevers for Scanning Force Microscopy”, Rev. Sci. Instrum. 64, 403 (1993).
4. D'Costa, N. P. and Hoh, J. H., “Calibration of Optical Lever Sensitivity for Atomic Force Microscopy”, Rev. Sci. Instrum. 66, 5096 (1995).
5. Evans, E. and Ritchie, K. “Dynamic Strength of Molecular Adhesion Bonds”, Biophysical Journal 72, 1541, (1997).
6. Bell, G. I., “Models for the Specific Adhesion of Cells to Cells”, Science 200, 618 (1978).
7. Ciarlo, D. R., “Silicon Nitride Thin Windows for Biomedical Microdevices”, Biomedical Microdevices 4, 63 (2002).
8. Griffel, W., “Handbook of Formulas for Stress and Strain”, Chapter V, Sections 50-51, Frederick Ungar Publishing Co., New York (1966).
9. Allen, M. G., Mehregany, M., Howe, R. T., and Senturia, S. D., “Microfabricated Structures for the In Situ Measurement of Residual Stress, Young's Modulus, and Ultimate Strain of Thin Films”, Appl. Phys. Lett. 51, 241 (1987).

### BRIEF SUMMARY OF THE INVENTION

It is an object of the invention to provide a coupled spring system for dynamic force measurements.

It is another object of the invention to provide a molecular force measurement system having a system spring constant that can be varied by positioning a microcantilever probe at different locations on a suspended thin film membrane.

A further object of the invention is to provide a molecular force measurement system having a system spring constant that can be softened without changing to a different microcantilever.

In a preferred embodiment, the invention is a coupled spring system for assessing interaction forces. It comprises a cantilever selected for the spring constant of its projecting arm, a probe located at the distal end of the projecting arm, and a supported membrane selected for its spring constant. The probe and supported membrane are positioned for measurement of the force between at least one molecule disposed on the probe and at least one molecule disposed on the supported membrane.

### BRIEF DESCRIPTION OF THE DRAWINGS

FIG. 1 shows a force-distance measurement typical of the prior art where biotin is tethered to a microcantilever probe and avidin is bound to a surface.

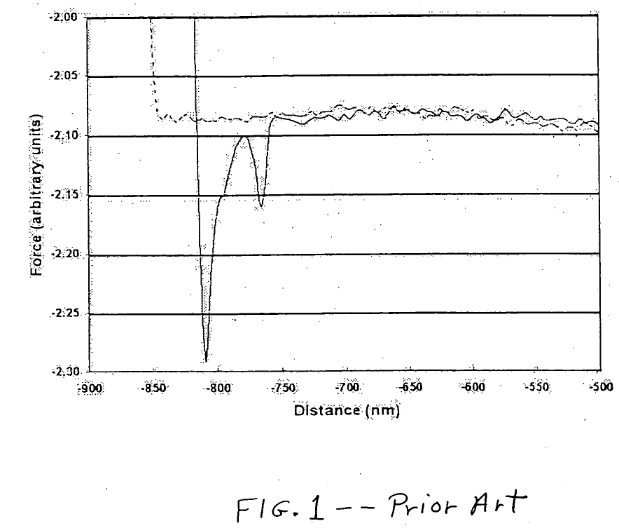

FIG. 2 shows the coupled spring system of the invention.

FIG. 3 shows examples of force-distance measurements using a suspended silicon nitride membrane and a microcantilever-mounted probe according to the invention. The figure illustrates that by positioning the microcantilever probe at different locations on the membrane surface, different effective spring constants (k_{eff}) can be obtained.

FIG. 4 illustrates an array of membrane structures fabricated on a single substrate, and their use with a plurality of microcantilevers.

### DETAILED DESCRIPTION OF THE INVENTION

Attractive forces between molecules are important to all chemical, physical, and biological processes and to materials as well. Techniques for assessing and/or measuring these forces are essential. The weak spring used in atomic force microscopy can be used for measuring forces between surfaces or between individual molecular pairs in virtually any environment (i.e., liquid, gas, vacuum). However, the technique is compromised by the need to evaluate microcantilevers possessing different spring constants. Ideally, the microcantilever spring constant should correlate with the forces being evaluated. For evaluating the weakest coupling forces, such as those commonly seen in biological systems, an extremely low or soft spring constant is needed.

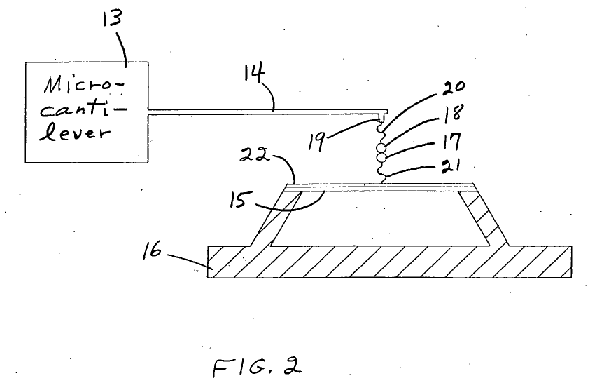

We provide a coupled spring system useful for evaluating force measurements under a variety of load rates. The coupled spring system shown in FIG. 2 allows for the utilization of various spring constants without changing microcantilevers. This alleviates time-consuming alignment of the optical system and extends the dynamic range of the force measurements.

In FIG. 2, the arm 14 of a microcantilever 13 provides the first spring. This is well known in the field. The second spring is a flexible thin film membrane 15 supported from a suitable base 16. In one embodiment, the membrane 15 would support a single target molecule 17 tethered to the membrane 15 by a tether 21. In this example, the target molecule 17 is one molecule of a molecular pair. The other molecule is the probe molecule of interest 18 tethered to the microcantilever probe 19 by a tether 20. The probe 19 could be any commonly used probe device such as an integrated or attached tip or tip structure, glass, latex, gold or silver bead, or just the distal end of the arm 14, for example. The tethers 20 and 21 could be linker molecules, for example.

The first spring of the coupled spring system can be provided by any microcantilever such as is commonly employed for atomic force microscopy. Microcantilevers are produced in a variety of shapes and possess spring constants in the range of 0.01-10 N/m. The probe 19 at the distal end of the arm 14 may have a radius of curvature on the order of 10 nm, and is used to probe a surface. This probe can be physically or chemically functionalized.

The second spring in the coupled spring system, the thin film membrane, may be such as has been used in a variety of sensor applications. Thin film membranes have been used, for example, as pressure sensors, infrared sensors, vacuum windows, acoustic devices and as microscopy substrates (Ciarlo, 2002)⁷. Membranes can be prepared from a variety of materials, including polymers, gold, silicon, silicon oxide and silicon nitride, for example. Silicon nitride membranes are commercially available from Structure Probe Inc. (West Chester, Pa.). Standard coating and etching processes, available from a number of MEMS foundries, can also be used to fabricate these membranes.

Since standard micromachining techniques are employed, the membrane 15 can be constructed of varying thicknesses and sizes. The spring constant of the membrane can be estimated from the elastic modulus (E) of the material, the thickness of the membrane (t) and size of the membrane (side length, a). For a square membrane, the spring constant (k) can be estimated from:

$$k = \frac{{Et}^{3}}{{Ka}^{2}}$$

where K is a dimensionless constant that depends on the geometry of the membrane (Griffel, 1966)⁸. More refined calculations that take into account the residual stress of the membrane can also be used to characterize the load-deflection behavior of the membrane (Allen 1987)⁹. Clearly, thinner and larger membranes will have lower spring constants. Square silicon nitride membranes on the order of 30 nm thick and 460 μm on a side are commercially available. The estimated spring constant for this membrane would be 0.012 N/m, not including estimated surface stresses.

In FIG. 2, an attachment layer 22 may be applied to the flexible membrane 15. This attachment layer serves to couple a target species to the surface. The target species could be one of a pair of reagents to be tested for an interaction, for example. The other member of the pair is tethered to the microcantilever probe. The attachment layer may serve further to reduce non-specific interactions (i.e., probe adhesion forces), control the density of target molecules on the surface, space the target species away from the surface, and facilitate the interaction between the pair of reagents.

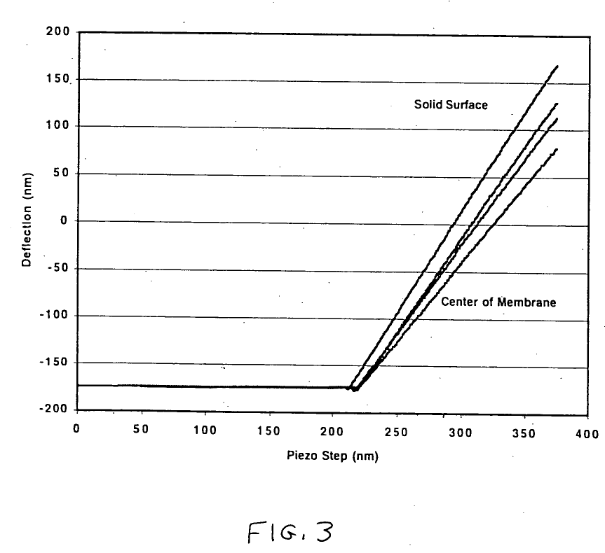

FIG. 3 shows an example of force-distance measurements using a suspended silicon nitride membrane and a microcantilever-mounted probe according to the invention. The membrane used for this demonstration was not optimized for measuring weak forces. Nevertheless, the effect of a coupled spring system on the force-distance curves is clearly seen. By positioning the microcantilever probe 19 at different locations or regions on the membrane 15 surface, different effective spring constants (k_{eff}) can be obtained. This result is observed as a change in slope of the force-distance curve in the region where contact is made with the surface. The softest effective spring constant is normally located at the center of the membrane. The effective spring constant can be determined directly from the force-distance curve. If the membrane spring constant (k₁) and the microcantilever spring constant (k₂) are known, then k_{eff} can be determined by the following relationship:

$${k}_{eff} = \frac{{k}_{1} {k}_{2}}{{k}_{1} + {k}_{2}} .$$

The principal benefit of coupling the two springs in the described manner is that the effective spring constant of the device will be lower than either spring alone. This is significant as the smallest force that can be measured depends on the spring constant of the system. The ability to change the system spring constant by using different positioning of the probe on the membrane surface enables evaluation of different loading rates without changing the microcantilever. This enables rapid collection of dynamic force measurements. Different membrane and microcantilever designs can be considered.

While the above discussion describes movement of the probe relative to the membrane, the membrane could be moved relative to a stationary probe just as well. It will also be appreciated that positioning of the probe on the membrane includes not only static placement of the probe relative to a membrane or target molecule, but also includes arranging for movement of the probe relative to the membrane or to the target molecule. Movement of a probe molecule relative to a target molecule is already done in some measurements in the field.

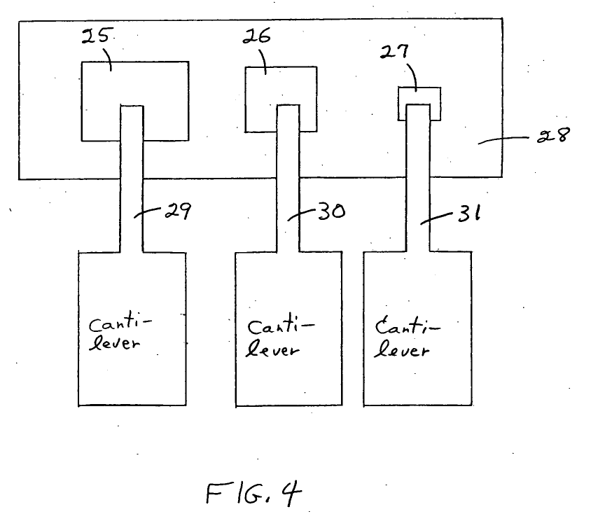

One or both of the above described springs can be fabricated in an array format for higher experimental throughput. FIG. 4, for example, shows an array of membrane structures 25, 26, 27 can be fabricated onto a single substrate 28. Individual membranes may be of different dimensions to produce different effective spring constants in combination with particular microcantilever springs 29, 30, 31 used with the membranes. Alternatively, the different membrane structures could also be coupled with different reagents for examination of an array of target reagents with a single microcantilever-mounted probe molecule. An array of microcantilever springs could also be fabricated to match the spatial separation of the different membrane structures. This could lead to the parallel evaluation of multiple probe molecules against an array of target reagents.

While the invention has been described with reference to a microcantilever device and a thin film membrane, it will be apparent that the invention is equally applicable to any size cantilever device and membrane structure. In like manner, while the invention has been described for the assessment and/or measurement of molecular forces, it is just as applicable to the measurement of forces between large numbers of molecules and to the measurement of forces between surfaces.

The ability to better measure adhesion forces afforded by our invention will improve biophysical studies of biomolecular interactions, including protein-protein, protein-DNA, and DNA-DNA interactions. Binding of potential pharmaceutical reagents to protein targets, as in drug discovery applications, is also likely. The technique can be used for both qualitative and quantitative evaluations.

While there has been shown and described what are at present considered the preferred embodiments of the invention, it will be obvious to those skilled in the art that various changes and modifications can be prepared therein without departing from the scope of the inventions defined by the appended claims.

1. A coupled spring system for assessing interaction forces comprising:
a cantilever selected for the spring constant of its projecting arm;
a probe located at the distal end of said projecting arm; and
a supported membrane selected for its spring constant, wherein said probe and said supported membrane are positioned for measurement of the force between at least one molecule disposed on said probe and at least one molecule disposed on said supported membrane.

2. The system of claim 1 wherein said cantilever is a microcantilever.

3. The system of claim 1 wherein said membrane is a thin film membrane.

4. The system of claim 1 wherein said at least one molecule disposed on said probe is tethered by a linker molecule.

5. The system of claim 1 wherein said at least one molecule disposed on the surface of said supported thin film membrane is tethered by a linker molecule.

6. The system of claim 1 wherein said at least one molecule disposed on said probe is a biomolecule.

7. The system of claim 1 wherein said at least one molecule disposed on the surface of said supported membrane is a biomolecule.

8. The system of claim 6 wherein said at least one biomolecule disposed on said probe is tethered by a linker molecule.

9. The system of claim 7 wherein said at least one biomolecule disposed on the surface of said supported membrane is tethered by a linker molecule.

10. The system of claim 1 wherein said thin film membrane is a micromachined thin film membrane.

11. The system of claim 1 further including a molecule attachment layer on said thin film membrane.

12. The system of claim 1 wherein said thin film membrane is a polymer.

13. The system of claim 1 wherein said thin film membrane is gold.

14. The system of claim 1 wherein said thin film membrane is silicon.

15. The system of claim 1 wherein said thin film membrane is silicon oxide.

16. The system of claim 1 wherein said thin film membrane is silicon nitride.

17. The system of claim 1 wherein said probe is physically functionalized.

18. The system of claim 1 wherein said probe is chemically functionalized.

19. The system of claim 1 wherein said thin film membrane further includes a probe structure on its surface for supporting said at least one molecule tethered to the surface of said supported thin film membrane.

20. The system of claim 1 further including a plurality of cantilevers selected for the spring constants of their projecting arms, said plurality of cantilevers having probes located at the distal ends of said projecting arms; and
a plurality of supported membranes, said membranes selected for their spring constants, wherein said probes are positioned for measurement of the forces between at least one molecule disposed on each of said probes and at least one molecule disposed on each of said supported membranes.

21. The system of claim 1 wherein said at least one molecule disposed on said probe is a plurality of molecules.

22. The system of claim 1 wherein said at least one molecule disposed on the surface of said supported thin film membrane is a plurality of molecules.

23. The system of claim 21 wherein said plurality of molecules is the surface of a material.

24. The system of claim 22 wherein said plurality of molecules is the surface of a material.
